(19) United States
(12) Patent Application Publication
(10) Pub. No.: US 2013/0321445 A1
(43) Pub. Date: Dec. 5, 2013

(54) COLORIZING USER INTERFACES

(71) Applicant: HARALD BUERNER, Mannheim (DE)

(72) Inventor: HARALD BUERNER, Mannheim (DE)

(21) Appl. No.: 13/485,945

(22) Filed: Jun. 1, 2012

(51) Int. Cl. G09G 5/02

(52) U.S. Cl. 345/589

(57) ABSTRACT

Various embodiments of systems and methods for colorizing user interfaces are described herein. In one aspect, the method includes receiving a request for rendering a user interface including a plurality of sections. Based upon the request, one or more identifiers associated with each of the plurality of sections are identified. Each identifier is assigned a color code. The color code may be assigned by a user. A user configured database table including the color code assignment for each identifier is accessed. Based upon the accessed database table, the plurality of sections is colorized according to the color code of their respective identifier. A colorized user interface including the plurality of colorized sections is rendered.

### BACKGROUND

User interfaces may comprise one or more images. Typically, each image has a specific color scheme. The color schemes of the images are typically specified by a developer. A user might wish to customize the color scheme of the images. Usually, the user modifies the color scheme of an image by modifying an original image provided by the developer. For example, the user may download the original image, modify the color scheme of the original image, and upload the modified image. Alternately, the user may replace the original image with a new image created by them. Therefore, users invest time and effort to create new image or modify the original image for customizing the color scheme as per their requirement.

Various tools enable the user to change the color scheme of the image without creating the new image or modifying the original image. For example, the tools may enable the user to select a required color for the image. Based upon the selected color, the color scheme of the image is automatically changed. Usually, the color scheme of all the images included on the user interface is changed to the selected color which may not be desirable. Also, if there is a single image on the user interface, the color of various sections of that image is changed to the selected color which again may not be desirable.

### BRIEF DESCRIPTION OF THE DRAWINGS

The invention is illustrated by way of example and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a user interface including multiple sections with each section individually colorize according to a color code of their respective identifier, according to an embodiment.

FIG. 2 is a flow chart illustrating the steps performed to colorize a user interface including multiple sections, according to an embodiment.

FIG. 3 is a flow chart illustrating the steps performed to colorize a web based user interface, according to an embodiment.

FIG. 4 is a block diagram of a system including a user interface colorizing module (UICM) to colorize a user interface, according to an embodiment.

FIG. 5 is a block diagram of the user interface (UI) including a single section assigned an identifier (ID) for performing colorization, according to an embodiment.

FIG. 6 is a block diagram of the UI including multiple sections with each section assigned a corresponding ID to perform colorization, according to an embodiment.

FIG. 7 is a block diagram of the UI including a single section comprising a complex multicolored image with multiple color areas with each color area assigned a corresponding ID to perform colorization, according to an embodiment.

FIG. 8 illustrates a database table including various IDs and their corresponding color code, according to an embodiment.

FIG. 9 is a block diagram of a colorized UI generated according to the color code of the ID associated with each color area of FIG. 7, according to an embodiment.

FIG. 10 is a block diagram of an exemplary computer system, according to an embodiment.

### DETAILED DESCRIPTION

Embodiments of techniques for colorizing user interfaces are described herein. In the following description, numerous specific details are set forth to provide a thorough understanding of embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

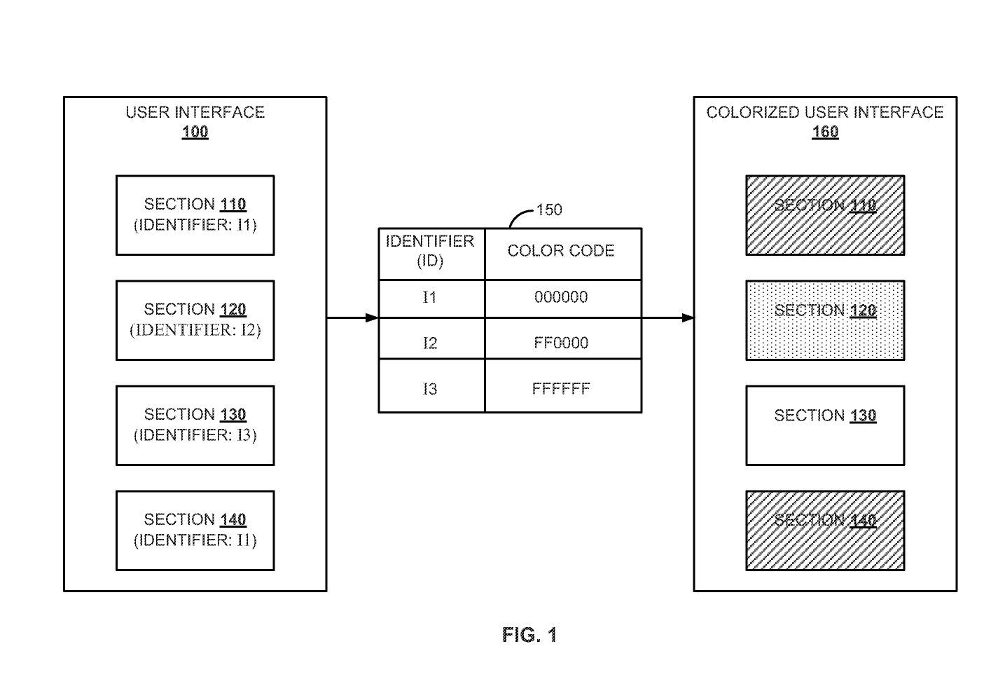

FIG. 1 illustrates one embodiment of a system to individually colorize multiple sections 110-140 of a user interface (UI) 100. Each section 110-140 of the UI 100 is assigned an identifier (ID). For example, the section 120 is assigned the identifier I2. In one embodiment, two or more sections of the UI 100 may be assigned same identifier. For example, the sections 110 and 140 are assigned the same identifier I1. Each identifier I1-I3 is assigned a color code. In one embodiment, a user assigns the color code for each identifier I1-I3. The color code may be in any suitable format, e.g., a hexadecimal format. In one embodiment, the user assigns the color code for each identifier I1-I3 by entering the color code for each identifier I1-I3 into a database table 150. For example, the user may assign or enter the color code ‘000000’ or the identifier I1, enters the color code ‘FF0000’ for the identifier I2, and enters the color code ‘FFFFFF’ for the identifier I3 into the database table 150. In one embodiment, the database table 150 is provided by a developer to enable user to assign color codes to the identifiers I1-I3. The table 150 is read to identify the color code of each identifier I1-I3. Once the color code of each identifier I1-I3 is identified, the sections 110, 120, 130, and 140 are colorized according to the color code of their respective identifiers I1, I2, I3, and I1. For example, the sections 110 and 140 are colorized ‘BLACK’ according to the color code ‘000000’ of their identifier I1, the section 120 is colorized ‘RED’ according to the color code ‘FF0000’ of its identifier I2, and the section 130 is colorized ‘WHITE’ according to the color code ‘FFFFFF’ of its identifier I3. The black, red, and white color is being shown as hashed area, dotted area, and white area, respectively, in FIG. 1. A colorized UI 160 is generated including the colorized sections 110-140. Finally, the colorized UI 160 is rendered.

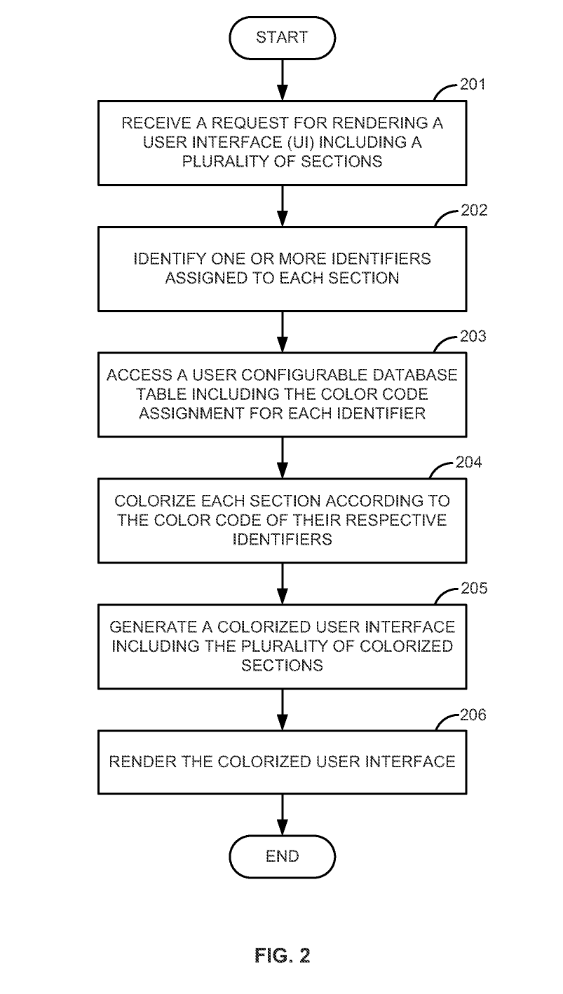

FIG. 2 is a flowchart illustrating a method for colorizing a user interface including a plurality of sections, according to one embodiment. The user interface (UI) includes the plurality of sections or screen parts, e.g., a background, a border, a text, etc. Each section has a specific color. A request for rendering the UI including the plurality of sections is received at step 201. In one embodiment, a binary representation of each section is retrieved. Each section is assigned one or more identifiers (IDs). In one embodiment, a simple section, e.g., a plain background may be assigned a single ID. In another embodiment, a complex section comprising multiple color area may be assigned multiple IDs, e.g., one ID assigned to each color area. The one or more IDs assigned to each section are identified at step 202. Each ID is assigned a color code. In one embodiment, a user, e.g., a customer assigns the color code to the IDs according to their requirement. These assignments of color codes to the IDs are stored in a database table. The database table can be configured or modified by the user. The user configurable database table including the color code assignment for each ID is accessed at step 203. Once the color code of each ID is identified, each section is colorized according to the color code of its respective one or more IDs at step 204. In one embodiment, the binary representation of the section is modified according to the color code of its one or more IDs and the section is colorized according to the modified binary representation. A colorized UI including the plurality of colorized sections is generated at step 205. The colorized UI is rendered at step 206. In one embodiment, if the database table is empty or there is no color code assigned for the IDs then the sections are colorized according to their predefined color codes. In another embodiment, if the database table is empty then predefined sections are automatically uploaded and rendered on the UI. In one embodiment, the UI is a non-web based UI. In another embodiment, the UI is a web based UI.

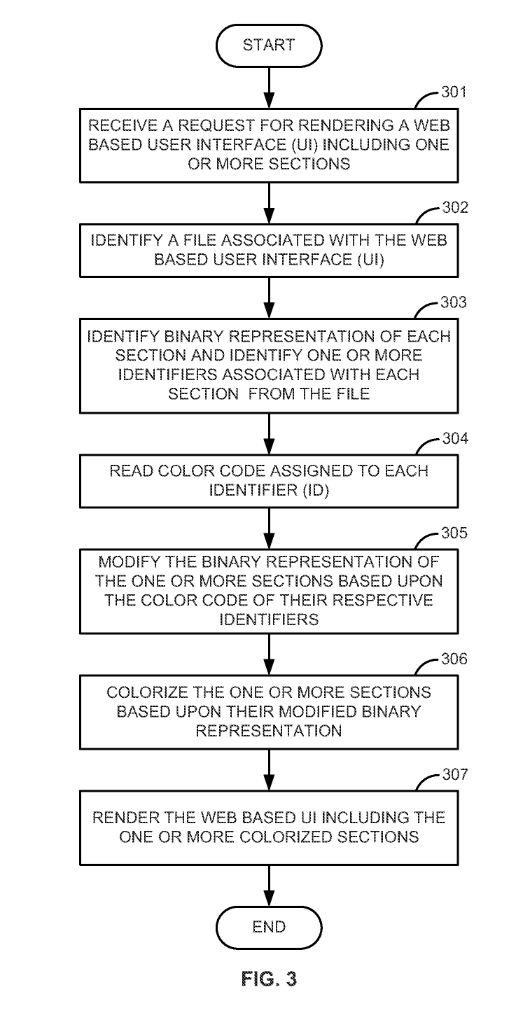

FIG. 3 is a flowchart illustrating a method for colorizing a web based UI, according to one embodiment. The web based UI is usually a hypertext markup language (HTML) page that includes the one or more sections and accessible through a web browser. The web browser may receive a request for rendering the web based UI including the one or more sections at step 301. The request may include a uniform resource locator (URL) or a path of the HTML resource from which web based UI is to be generated. Based upon the request, a file, e.g., a cascading style sheets (CSS) file, associated with the web based UI is identified at step 302. Various information related to the web based UI is stored in the file. For example, the URLs of the sections are stored in the file. The binary representations of the one or more sections of the web based UI and the one or more IDs associated with each section of the web based UI are identified from the file at step 303. In one embodiment, the one or more IDs associated with each section of the web based UI are identified from the request itself. Once the one or more IDs are identified, the color code assigned to each ID is read at step 304. In one embodiment, the color code of each ID may be read from the database table configured by the user. The binary representations of the one or more sections are modified based upon the color codes of their respective IDs at step 305. The one or more color sections are colorized based upon their modified binary representation at step 306. The web based UI including the colorized sections are rendered at step 307.

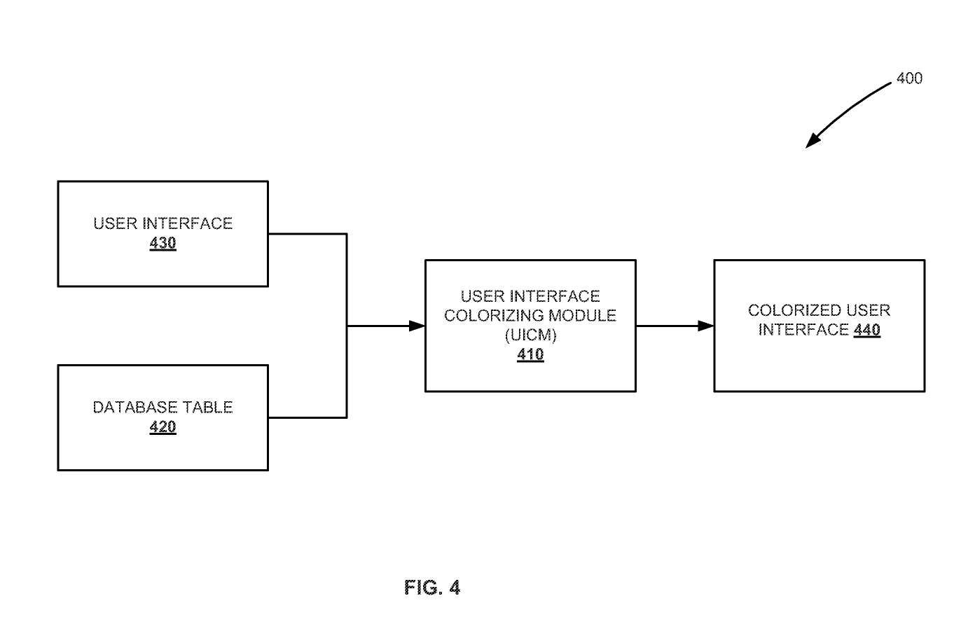

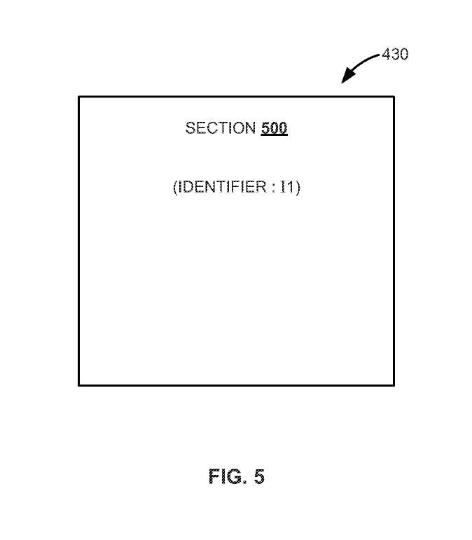

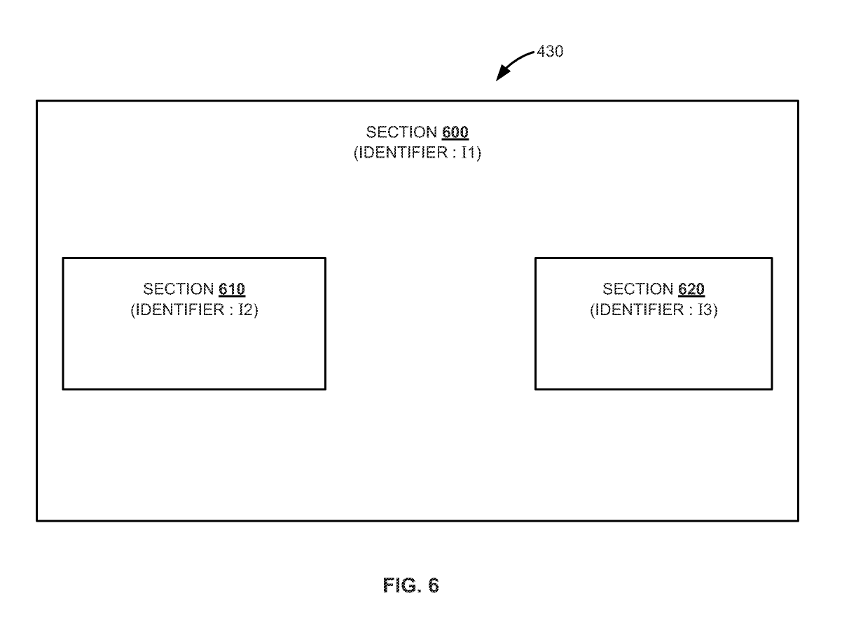

In one embodiment, as illustrated in FIG. 4, a system 400 includes a user interface colorizing module (UICM) 410 communicatively coupled to a database table 420 for colorizing a user interface 430. The user interface 430 may include one or more sections or images (not shown). Each section or image has a specific color. A request for displaying the user interface 430 including the one or more sections is received by the UICM 410. In one embodiment, based upon the request, a binary representation of the one or more sections is retrieved. Each section may be assigned one or more tags. A tag may be an identifier or ID. In one embodiment, as shown in FIG. 5, the UI 430 may include a single section 500, e.g., a plain background, associated with a single identifier I1. In another embodiment, as shown in FIG. 6, the UI 430 may include multiple sections, e.g., 600-620 and each section 600-620 is assigned a respective identifier I1-I3. The identifier I1-I3 associated with respective section 600-620 is identified by the UICM 410. In one embodiment, multiple sections may have same identifier or ID. Each identifier I1-I3 is assigned a color code. The color code of the identifier represents the color in which the section associated with the identifier has to be colorized. For example, the color code of the identifier I2 represents the color in which the section 610 has to be colorized. In one embodiment, the database table 420 stores the identifiers I1-I3 and their corresponding color code. The database table 420 is read to identify the color code of each identifier I1-I3 associated with the section 600-620, respectively. Once the color code of each identifier I1-I3 is identified, the sections 600-620 of the UI 430 are colorized according to the color codes of their respective identifier I1-I3. In one embodiment, the binary representations of the section 600-620 are modified according to the color code of their respective identifier I1-I3. The sections 600-620 are colorized based upon their modified binary representation. A colorized UI 440 including the colorized sections is generated. The colorized UI 440 is finally rendered.

In one embodiment, the UI 430 may be a web based UI which is included within a web based software application, e.g., Net Weaver Business Client for hypertext markup language (NWBC for HTML), developed by SAP®. The web based software application or the web based UI is accessible through an internet. In another embodiment, the UI 430 may be a non-web based UI which can be accessed without the internet.

The UI 430 may include one or more sections or screen parts. For example, the UI 430 may include the single section 500 as shown in FIG. 5. In one embodiment, the UI 430 may include multiple sections 600-620 as shown in FIG. 6. Each section 600-620 has the specific color. In one embodiment, each section 600-620 may be a separate image.

The image may be in any suitable format, e.g., a graphics interchange format or GIF (represented by extension .gif), a portable network graphics or PNG (represented by extension .png), a joint photographic experts group or JPEG (represented by extension .jpg), and a tagged image format or TIF (represented by extension .tif), etc. In one embodiment, the non-web based UI 430 includes the image in the JPEG or TIF format. In another embodiment, the web based UI 430 includes the image in the PNG or the GIF format.

In one embodiment, the UI 430 includes the single section 500 comprising a simple mono colored image like the plain background, as illustrated in FIG. 5. The UI 430 including the section 500 comprising the mono colored image may be represented as “body{background-image: (<address or path of the image of section 500>);}.” In one embodiment, if the UI 430 is the web based UI, the address or path of the image includes, e.g., a uniform resource locator (URL) of the image and the UI 430 may then be represented as “body{background-image url(http://pics/cssT/image of section 500.png);}.” In another embodiment, if the UI 430 is the non-web based UI, the address or path of the images may be, e.g., a local address of the images and the UI 430 may be represented as “body{background-image: (pics/cssT/imageof section 500.png);}.”

In one embodiment, the UI 430 includes multiple sections 600-620, as illustrated in FIG. 6. Each section 600-620 comprises the simple mono colored image. The UI 430 including the sections 600-620 may be represented as shown below:

body {background-image: (<address or path of the image of the
section 600>); }
body {background-image: (<address or path of the image of the
section 610>); }
body {background-image: (<address or path of the image of the
section 620>);}

In one embodiment, if the UI 430 is the web based UI, the address or path of the images may be, e.g., the uniform resource locator (URL) of the images and the UI 430 may be represented as shown below:

body {background-image: url(http://pics/cssT/image of the section
600.png); }
body {background-image: url(http://pics/cssT/image of the section
610.png); }
body {background-image: url(http://pics/cssT/image of the section
620.png);}

In one embodiment, if the UI 430 is the non-web based UI, the address or path of the images may be, e.g., the local address of the images and the UI 430 may be represented as shown below:

body {background-image: (pics/cssT/image of the section
600.jpg); }
body {background-image: (pics/cssT/image of the section
610.jpg); }
body {background-image: (pics/cssT/image of the section
620.jpg);}

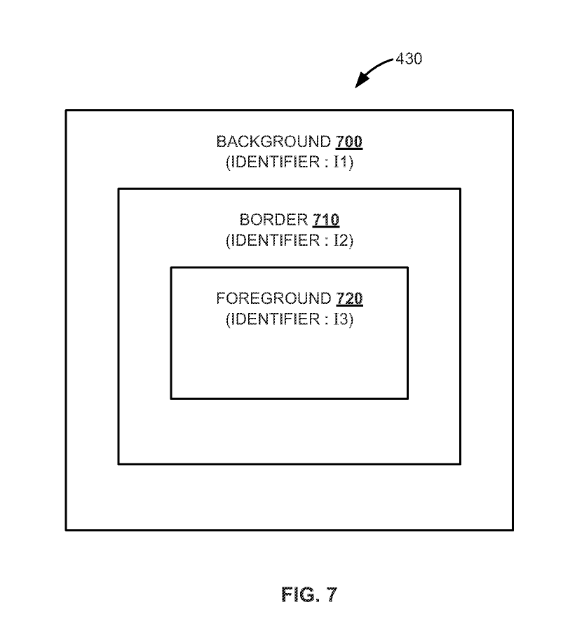

Referring to FIG. 7, in one embodiment, the UI 430 includes a section comprising a complex image with multiple color areas. For example, the UI 430 includes a section (not shown) comprising the color areas such as a background 700, a border 710, and a foreground 720. In one embodiment the complex or multicolored image may be represented in a layered image format, e.g., in the GIF format which includes multiple layers or color palettes. Each color area 700-720 is represented by a specific color palette. For example, in the layered image format e.g., the GIF format, the UI 430 may be represented by the plurality of layers or color palettes. Various color areas, e.g., 700-720 are realized by a separate layer or color palette coded sequentially within the multicolored image. Each color palette contains various shades of a certain color. For example, a color palette #1 (representing color area 700 or background) may include certain shade of color ‘Black,’ a color palette #2 (representing color area 710 or border) may include certain shade of color ‘Blue,’ and the color palette #3 (representing color area 720 or text) may include certain shade of color ‘Green.’ Colors ‘Black, Blue, and Green’ are main colors of the three palettes or color areas 700-720, respectively, of the complex or multicolored image.

The UI 430 including the single section comprising the complex multicolored image with multiple color areas may be represented as “body{background-image:

(<address or path of the multicolored image>? ID_areas=
area1| area2| area3); }”
where area1= color area 700, area2= color area 710, and area3=
color area 720.
Alternately, the UI 430 may also be represented as “body
{background-image: (<address or path of the multicolored
image>? ID_areas=background 700| border 710|
foreground 720); }”

In one embodiment, if the UI 430 is the web based UI, the address or path of the images may be the uniform resource locator (URL) of the images and the UI 430 including the complex multicolored image with multiple color areas may be represented as “body{background-image: url(http://pics/cssT/multicolored image.gif?ID_areas=area1|area2|area3);}” or “body{background-image: url(http://pics/cssT/multicolored image.gif?ID_areas=background 700|border|border 710|foreground 720);}” In another embodiment, if the UI 430 is the non-web based UI 430, the address or path of the images may be, e.g., the local address of the images and the UI 430 including the multicolored image with multiple color areas in GIF format may be represented as “body {background-image: (pics/cssT/multicolored image.gif?ID_areas=area1|area2|area3);}” or “body{background-image: (pics/cssT/multicolored image.gif?ID_areas=background 700|border 710|foreground 720);}”

Each color area or each section is assigned the identifier or ID. In one embodiment, the section 500 including the single mono colored image is assigned a single identifier I1, as shown in FIG. 5. In one embodiment, the identifier I1 may be assigned to the section 500 as “body{background-image: (<address of the image of section 500>?IDName=I1);}.”

In one embodiment, if the UI 430 includes multiple sections 600-620 with each section comprising a separate mono colored image then identifier I1-I3 may be assigned to sections 600-620, respectively, as shown below:

body {background-image: (<address of the image of the section
600>?IDName= I1); }
body {background-image: (<address of the image of the section
610>?IDName= I2); }
body {background-image: (<address of the image of the section
620>?IDName= I3}.

In one embodiment, if the UI 430 includes the single section comprising the complex multicolored image with multiple color areas, e.g., 700-720, then the section may be assigned identifiers or IDs corresponding to each color area. For example, the identifiers I1-I3 may be assigned to the color areas 700-720, respectively, as shown in FIG. 7. The identifiers I1-I3 may be assigned as “background-image: (<path of the multicolored image.gif>?IDName=I1|I2|I3)”. The identifiers I1-I3 are assigned sequentially to the areas (area1-area3) or color area 700-720, respectively. Alternately, the identifiers I1-I3 may be considered to be assigned to the color palette #1-color palette #3, respectively.

In one embodiment, each identifier I1-I3 may be assigned a suitable name by the developer. For example, the identifier I1 may be assigned a name “BACKGROUND_OF_NAVIGATION_PANEL.” Each identifier I1-I3 is assigned the color code. The color code of the identifier represents the color in which the section or color area associated with the identifier has to be colorized. For example, the color code of the identifier I2 represents the color in which the section 610 (FIG. 6) or the color area 710 (FIG. 7) has to be colorized.

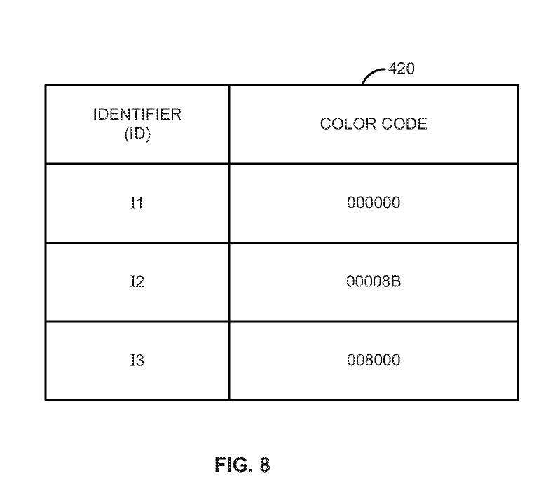

In one embodiment, the color code of the identifiers is stored in the database table 420. FIG. 8 illustrates an exemplarily database table 420 including the identifiers I1-I3 and their corresponding color codes. For example, the color code of the identifier I1 is 000000, identifier I2 is 00008B, and identifier I3 is 008000, color codes being expressed in a hexadecimal format. The color code may be in any other suitable format. The database table 420 may be configurable or modifiable by the user, e.g., the customer. The user may modify the color code of the identifiers I1-I3 according to their requirement. In one embodiment, an empty database table 420 (i.e., without color assignment for identifiers I1-I3) may be provided to the user and the user can configure or assign the color codes to the identifiers I1-I3 according to their requirement.

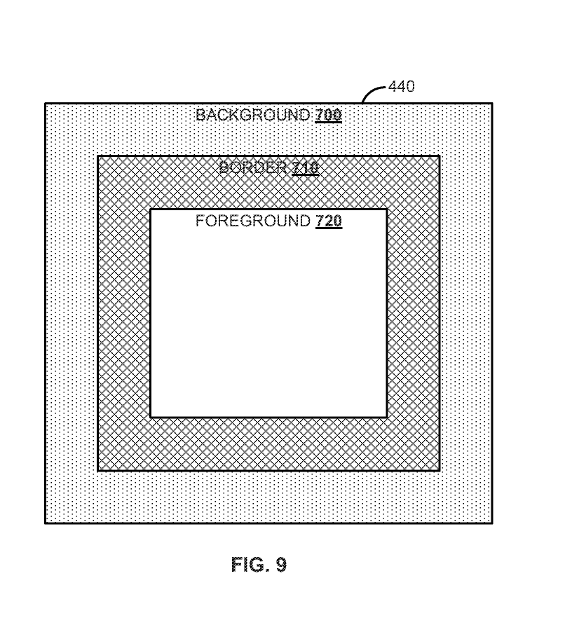

The color codes of the identifiers I1-I3 are read by the UICM 410. The UICM 410 colorizes the sections, e.g., 600-620 or the color area 700-720 of the UI 430 according to the color codes of their respective identifiers I1-I3. For example, the color area 700 may be colorized BLACK (as per the color code 000000 of the identifier I1), the color area 710 may be colorized BLUE (as per the color code 00008B of the identifier I2), and the color area 720 may be colorized GREEN (as per the color code 008000 of the identifier I3). FIG. 9 illustrates the BLACK, BLUE, and GREEN colored areas 700-720 as dotted area, crossed lines area, and white area, respectively. In one embodiment, the foreground 720 may be a “text” which may not be realized with the image and therefore, may not be colorized using the tagging technique or identifier assignment technique. If the foreground 720 cannot be colorized using the tagging technique, the user may need to change backend code to colorize the foreground 720 or the text as per their requirement

In one embodiment, if the database table 420 is empty or the user does not assign any color code to any identifiers I1-I3, the UICM 410 uploads and renders the color areas or the sections in a default color scheme provided by the developer (i.e., signature design). Alternately, if the database table 420 is empty, the UICM 410 does not modify the binary representation of the color areas 700-720 and therefore, the color areas 700-720 is rendered in the default color scheme provided by the developer. In another embodiment, if the user assigns color code to only few identifiers, e.g., identifier I2, then the UICM 410 uploads the predefined sections or color areas as it is and only modifies the color area 710 or the section 610 that is represented by the identifier I2 whose color code is modified.

Embodiments described above provide an efficient method for colorizing a user interface (UI). Use of identifiers or IDs for various different sections of the UI ensures that each section included on the UI can be customized separately. For example, each section can be separately or independently colorized. Further, ID assignment can be more granular. For example, the ID may be assigned to different parts of the same section or the same image. Therefore, various portions of a single section can also be separately customized/colored. A user, e.g., a customer, just need to specify or assign the color of their choice for various IDs and the system would automatically customize the color of the sections or various portions of the section accordingly. Further, the sections (on the same UI or different UIs) having the same ID can be colorized at once by single color code assignment. Therefore, the method is user friendly, convenient, and efficient. Also, the system saves time and effort that might be wasted in modifying the image or creating a new image. The tagging or ID assignment concept can also be extended to separately customize other parameters of various sections of the UI, e.g., intensity, transparency, etc. Therefore, the system is flexible and extensible.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise cany a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

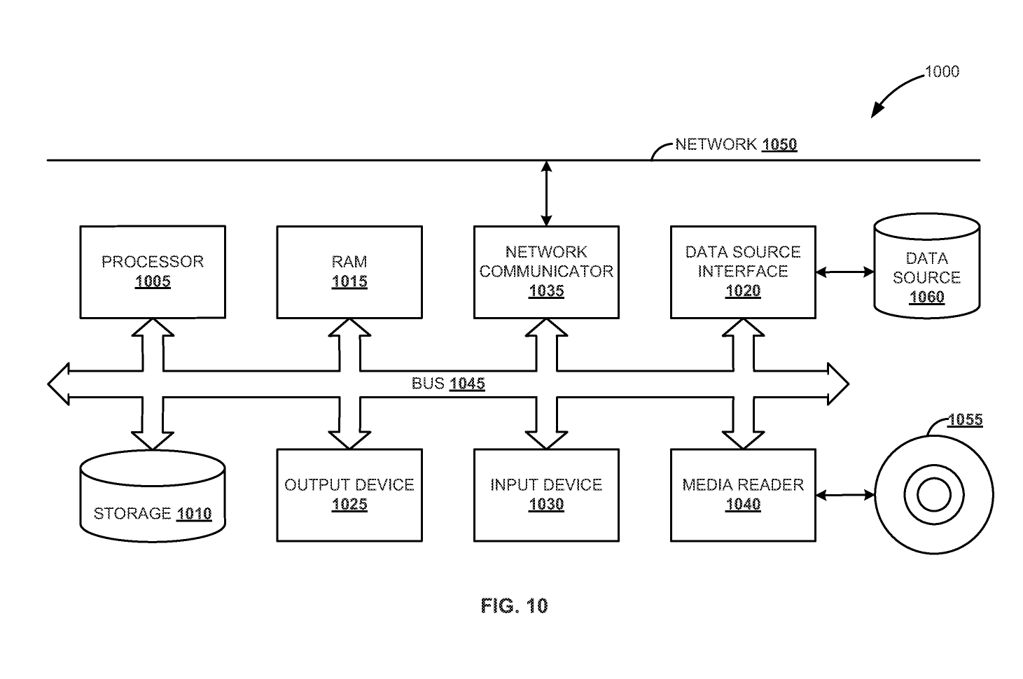

FIG. 10 is a block diagram of an exemplary computer system 1000. The computer system 1000 includes a processor 1005 that executes software instructions or code stored on a computer readable storage medium 1055 to perform the above-illustrated methods. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. The stored instructions may be further compiled to generate other representations of the instructions and dynamically stored in the RAM 1015. The processor 1005 reads instructions from the RAM 1015 and performs actions as instructed. According to one embodiment, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000, Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a non-transient computer readable storage medium to tangibly store instructions, which when executed by one or more computers in a network of computers causes performance of operations comprising:
receiving a request for rendering a user interface including a plurality of sections;
identifying one or more identifiers associated with each of the plurality of sections;
accessing a user configurable database table including a color code assignment for each identifier;
based upon the accessed database table, colorizing the plurality of sections according to the color code of their respective identifier;
generating a colorized user interface including the plurality of colorized sections; and
rendering the colorized user interface.

2. The article of manufacture of claim 1, wherein colorizing the plurality of sections comprises retrieving a binary representation of each of the plurality of sections, modifying the binary representation of each of the plurality of sections based upon tire color code of their respective identifiers, and colorizing the plurality of sections according to their modified binary representation.

3. The article of manufacture of claim 1, wherein at least one section from the plurality of sections includes one or more color areas and each color area is assigned an identifier.

4. The article of manufacture of claim 3, wherein colorizing the at least one section including the one or more color areas comprises colorizing the one or more color areas according to the color code of their respective identifier.

5. The article of manufacture of claim 1 further comprising instructions which when executed cause the one or more computers to perform the operations comprising:
determining whether the database table includes the color code assignment; and
when the database table does not include the color code assignment, colorizing the plurality of sections according to their respective predefined color codes.

6. The article of manufacture of claim 1, wherein the user interface is a web based user interfaces accessible through an internet.

7. A method for colorizing a user interface, the method comprising:
receiving a request for rendering the user interface including a plurality of sections;
identifying one or more identifiers associated with each of the plurality of sections;
accessing a user configurable database table including a color code assignment for each identifier;
based upon the accessed database table, colorizing the plurality of sections according to the color code of their respective identifier;
generating a colorized user interface including the plurality of colorized sections; and
rendering the colorized user interface.

8. The method of claim 7 further comprising:
determining whether the database table includes the color code assignment; and
when the database table does not include the color code assignment, colorizing the plurality of sections according to their respective predefined color codes.

9. The method of claim 7 further comprising:
based upon the request, identifying a file associated with the user interface;
identifying a binary representation of each of the plurality of sections from the file;
modifying the binary representation of each of the plurality of sections based upon the color code of their respective identifiers; and
colorizing the plurality of sections according to their modified binary representation.

10. The method of claim 9 further comprising:
downloading the file; and
retrieving information related to the one or more identifier from the downloaded file.

11. The method of claim 7, wherein at least one section from the plurality of sections includes one or more color areas and each color area is assigned an identifier.

12. The method of claim 11, wherein colorizing the at least one section including the one or more color areas comprises colorizing the one or more color areas according to the color code of their respective identifier.

13. A computer system for colorizing a user interface comprising:
a memory to store program code; and
a processor communicatively coupled to the memory, the processor configured to execute the program code to cause one or more computers in a network of computers to:
receive a request for rendering the user interface including a plurality of sections;
identify one or more identifiers associated with each of the plurality of sections;
access a user configurable database table including a color code assignment for each identifier;
based upon the accessed database table, colorize the plurality of sections according to the color code of their respective identifier;
generate a colorized user interface including the plurality of colorized sections; and
render the colorized user interface.

14. The computer system of claim 13, wherein the processor is further configured to perform the operations comprising:
based upon the request, identifying a file associated with the user interface;
identifying a binary representation of each of the plurality of sections from the file;
modifying the binary representation of each of the plurality of sections based upon the color code of their respective identifiers; and
colorizing the plurality of sections according to their modified binary representation.

15. The computer system of claim 14, wherein the processor is further configured to perform the operations comprising:
downloading the file; and
retrieving information related to the one or more identifier from the downloaded file.

16. The computer system of claim 14, wherein the file is a cascading style sheets (CSS) file.

17. The computer system of claim 13, wherein the processor is further configured to perform the operations comprising:
determining whether the database table includes the color code assignment; and
when the database table does not include the color code assignment, colorizing the plurality of sections according to their respective predefined color codes.

18. The computer system of claim 13, wherein at least one section from the plurality of sections includes one or more color areas and each color area is assigned an identifier.

19. The computer system of claim 18, wherein colorizing the at least one section including the one or more color areas comprises colorizing the one or more color areas according to the color code of their respective identifier.

20. The computer system of claim 13, wherein the user interface is a web based user interfaces accessible through an internet.
